(19) United States
(12) Patent Application Publication
(10) Pub. No.: US 2010/0329362 A1
(43) Pub. Date: Dec. 30, 2010

(54) VIDEO ENCODING AND DECODING APPARATUS AND METHOD USING ADAPTIVE IN-LOOP FILTER

(75) Inventors: Byeong-Doo CHOI, Siheung-si (KR); Dae-Sung CHO, Seoul (KR); Dong-Gyu SIM, Seoul (KR); Kwang-Soo JUNG, Seoul (KR)

Correspondence Address: SUGHRUE MION, PLLC, 2100 PENNSYLVANIA AVENUE, N.W., SUITE 800, WASHINGTON, DC, 20037, US

(73) Assignees: SAMSUNG ELECTRONICS CO., LTD., Suwon-si (KR); KWANGWOON UNIVERSITY INDUSTRY-ACADEMIC COLLABORATION FOUNDATION, Seoul (KR)

(21) Appl. No.: 12/827,572

(22) Filed: Jun. 30, 2010

Related U.S. Application Data
(60) Provisional application No. 61/221,780, filed on Jun. 30, 2009.

(51) Int. Cl. H04N 7/26

(52) U.S. Cl. 375/240.29; 375/E07.193

(57) ABSTRACT

An in-loop filtering method and apparatus for video encoding, the in-loop filtering method including: determining a type of a boundary of an image block to be filtered by using context information of the image block; adaptively creating a filter for filtering the boundary of the image block according to the determined type; selecting a filter for filtering the image block between the created filter and a previously stored filter; and filtering the image block by using the selected filter.

### CROSS-REFERENCE TO RELATED PATENT APPLICATION

This application claims the benefit of U.S. Provisional Application No. 61/221,780, filed on Jun. 30, 2009, the entire disclosure of which is hereby incorporated by reference.

### BACKGROUND

1. Field

Apparatuses and methods consistent with exemplary embodiments generally relate to a video encoding and decoding apparatus and method, and more particularly, to a video encoding and decoding apparatus and method using an adaptive in-loop filter, in which an efficiency of video encoding is improved by enhancement of a performance of the in-loop filter.

2. Description of Related Art

Encoding techniques for video compression, such as H.261, H.263, Moving Picture Experts Group (MPEG)-1, MPEG-2, MPEG-4, and H.264/Advanced Video Codec (AV), generally include processes such as motion estimation/compensation, transform and quantization, entropy encoding, and so forth.

Such video encoding techniques perform encoding in block units. However, due to block-based transform and quantization, visually artificial discontinuity in pixel values occurs in a block boundary, which is referred to as a blocking phenomenon.

To alleviate quality degradation caused by the blocking phenomenon, H.264/AVC uses as an in-loop filter, a deblocking filter which allows fine motion estimation/compensation in an encoding process.

However, the deblocking filter used in H.264/AVC is designed to be suitable for low-bitrate images. As a result, for high-definition images having a high bitrate, the deblocking filter may have no effect or even degrade an encoding performance.

That is, a related art in-loop filter applies a plurality of statistic filters to images, which have been reconstructed after encoding, based on context information. The context information includes an encoding mode, an image block boundary unit, a transform coefficient, a motion size, reference frame information, and the like.

However, the related art in-loop filter is limitedly suitable for an image having a particular size or particular characteristics due to the use of the statistic filters. Consequently, the deblocking filter may have no effect on images having various characteristics or even degrade encoding performance for such images.

### SUMMARY

Aspects of tone or more exemplary embodiments provide a method and apparatus for creating an adaptive in-loop filter, taking account of characteristics of an image during video encoding.

Moreover, aspects of one or more exemplary embodiments provide a method and apparatus for creating an adaptive in-loop filter and updating the in-loop filter during video encoding.

Furthermore, aspects of one or more exemplary embodiments provide a method and apparatus for creating an adaptive in-loop filter, taking account of characteristics of an image during video decoding.

In addition, aspects of one or more exemplary embodiments provide a method and apparatus for updating an adaptive in-loop filter during video decoding.

According to an aspect of an exemplary embodiment, there is provided an in-loop filtering method for video encoding, the method including: determining a type of a boundary of an image block to be filtered by using context information of the image block; adaptively creating a filter for filtering the boundary of the image block according to the determined type, selecting a filter for filtering the image block between the created filter and a previously stored filter; and filtering the image block by using the selected filter.

According to an aspect of another exemplary embodiment, there is provided an in-loop filtering apparatus for video encoding, the apparatus including: a filter creating unit which determines a type of a boundary of an image block to be filtered by using context information of the image block, and which adaptively creates a filter for filtering the boundary of the image block according to the determined type; a filter selecting unit which selects a filter for filtering the image block between the created filter and a previously stored filter; and a filtering performing unit which filters the image block by using the selected filter.

According to an aspect of another exemplary embodiment, there is provided an in-loop filtering method for video decoding, the method including: receiving filter information regarding a filter used to filter an image block from a video encoding apparatus; when the received filter information includes filter coefficient information, filtering the image block by using a filter corresponding to the filter coefficient information; and when the received filter information includes information of a previously stored filter, filtering the image block by using a filter corresponding to the information.

According to an aspect of another exemplary embodiment, there is provided an in-loop filtering apparatus for video decoding, the apparatus including: a filter information receiving unit which receives filter information regarding a filter used to filter an image block from a video encoding apparatus; and a filtering performing unit which filters the image block by using a filter corresponding to filter coefficient information when the received filter information includes the filter coefficient information, and which filters the image block by using a filter corresponding to index information when the received filter information includes the index information of a previously stored filter.

According to an aspect of another exemplary embodiment, there is provided a method of adaptively creating a filter for an in-loop filtering of an image block, the method including: determining a type of a boundary of the image block by using context information of the image block; and adaptively creating the filter for filtering the boundary of the image block according to the determined type of the boundary.

According to an aspect of another exemplary embodiment, there is provided an in-loop filtering method for video decoding, the in-loop filter method including: receiving filter information regarding a filter used to filter an image block from a video encoding apparatus; and filtering the image block by using the filter, wherein the filter is adaptively based on a type of a boundary of the image block.

### BRIEF DESCRIPTION OF THE DRAWINGS

The above and/or other aspects will be more apparent from the following detailed description taken in conjunction with the accompanying drawings, in which:

FIG. 1 is a block diagram illustrating a video encoding apparatus according to an exemplary embodiment;

FIG. 2 is a block diagram illustrating an example of an in-loop filter according to an exemplary embodiment;

FIG. 3 illustrates examples of a two-dimensional (2D) filter having a size of N×N and a one-dimensional (1D) filter having a size of N according to an exemplary embodiment;

FIG. 4 is a flowchart illustrating an in-loop filtering method performed by an encoder according to an exemplary embodiment;

FIG. 5 is a block diagram illustrating a video encoding apparatus according to an exemplary embodiment;

FIG. 6 is a block diagram illustrating a video decoding apparatus according to an exemplary embodiment; and

FIG. 7 is a flowchart illustrating an in-loop filtering method performed by a decoder according to an exemplary embodiment.

### DETAILED DESCRIPTION OF EXEMPLARY EMBODIMENTS

Hereinafter, exemplary embodiments will be described in detail with reference to the accompanying drawings. Throughout the drawings, like components are referred to by like reference numerals. In the following description, well-known functions or constructions are not described in detail since they would obscure the invention in unnecessary detail. Expressions such as “at least one of,” when preceding a list of elements, modify the entire list of elements and do not modify the individual elements of the list.

Before exemplary embodiments are described in detail, a basic concept of one or more exemplary embodiments will now be described in brief. To create an in-loop filter used for video encoding and decoding, one or more exemplary embodiments determine a type of a boundary of an image block by using context information of the image block, create the filter adaptively according to the determined type, and select an optimal filter between the created filter and a previously created and stored filter. By using the selected filter, filtering is performed. Hereinafter, exemplary embodiments will be described in detail.

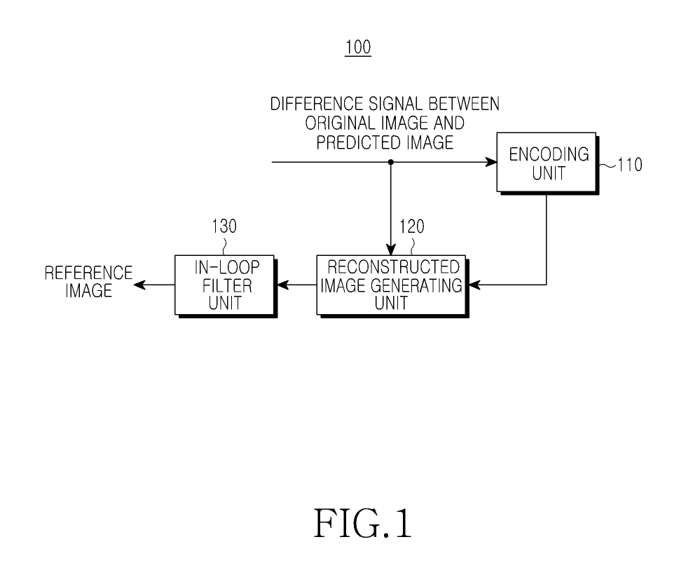

FIG. 1 is a block diagram illustrating a video encoding apparatus 100 according to an exemplary embodiment. Referring to FIG. 1, the video encoding apparatus 100 includes an encoding unit 110, a reconstructed image generating unit 120, and an in-loop filter unit 130.

The encoding unit 110 encodes a difference signal between an original image to be currently encoded and a predicted image corresponding to the original image. The encoding unit 110 encodes the difference signal through at least one of Discrete Cosine Transform (DCT), quantization, entropy encoding, and the like. The DCT, quantization, and entropy encoding are widely used in the H.264 standard and thus will not be described in detail.

The reconstructed image generating unit 120 reconstructs the encoded difference signal and generates a reconstructed image by using the reconstructed difference signal and the predicted image. More specifically, the reconstructed image generating unit 120 reconstructs the encoded difference signal through inverse quantization and Inverse Discrete Cosine Transform (IDCT), and adds the reconstructed signal to the predicted image, thus generating the reconstructed image.

The in-loop filter unit 130 performs filtering on the reconstructed image in the unit of an image block based on a scheme according to an exemplary embodiment. The image block unit may not be fixed and may be variable. For example, an image may be divided into quadtree units and different filters may be applied to blocks having different sizes for filtering. The image block unit may be referred to by various names, for example, a coding unit, a prediction unit, and a transform unit.

To be specific, the in-loop filter unit 130 determines a type of a block boundary of the reconstructed image by using context information, and creates a filter corresponding to the determined type in order to minimize bitrate distortion between the reconstructed image and the original image corresponding to the reconstructed image. Thereafter, the in-loop filter unit 130 compares the created filter with one or more previously stored filters to select an optimal filter therefrom, and performs filtering by using the selected filter.

To create a filter, various context information may be used. For example, the filter may be created according to at least one of a boundary strength of an image block, a pixel position with respect to a boundary of an image block, a macroblock encoding mode, whether a macroblock encoding mode is a skip mode, a Coded Block Pattern (CBP), a Quantization Parameter (QP), and a motion vector.

The created deblocking filter may be a one-dimensional (1D) filter having a size of N or a two-dimensional (2D) filter having a size of N×N. Furthermore, the size of the created deblocking filter may not be fixed and may be variable. The in-loop filter unit 130 filters the reconstructed image by using the created filter or the stored filter, and information related to the filter used for the filtering is encoded by the encoding unit 110.

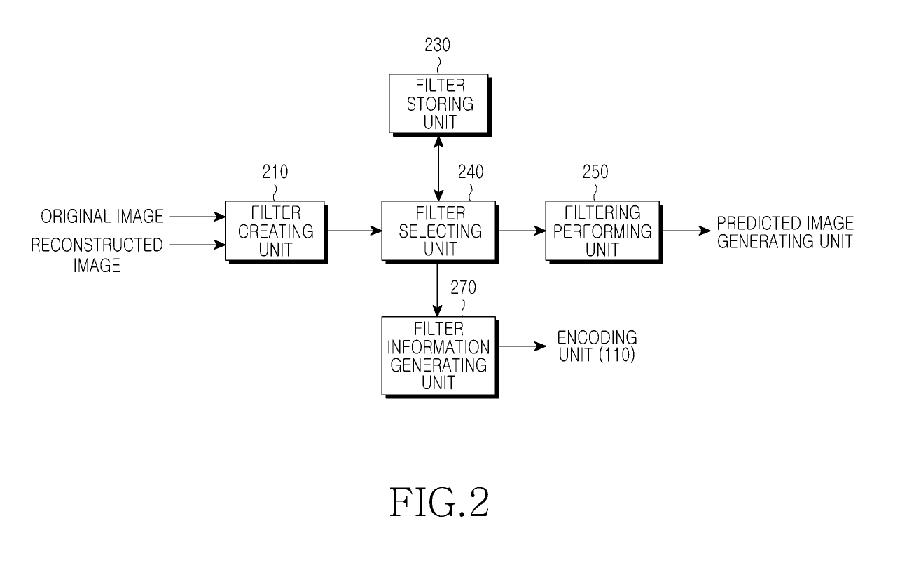

Hereinafter, the in-loop filter unit 130 will be described in detail with reference to FIG. 2. FIG. 2 is a diagram for describing an example of the in-loop filter unit 130 according to an exemplary embodiment. Referring to FIG. 2, the in-loop filter unit 130 includes a filter creating unit 210, a filter storing unit 230, a filter selecting unit 240, a filtering performing unit 250, and a filter information generating unit 270.

The filter creating unit 210 determines a type of a boundary of an image block by using context information, creates a filter corresponding to the determined type in order to minimize bitrate distortion between a reconstructed image and an original image corresponding thereto, and delivers filter coefficient information of the created filter to the filter selecting unit 240.

The context information may include, for example, at least one of a boundary strength of an image block, a pixel position with respect to a boundary of an image block, a macroblock encoding mode, whether or not a macroblock encoding mode is a skip mode, a CBP, a QP, a motion vector, etc. That is, the filter creating unit 210 determines a type of a boundary of an image block by using at least one of the context information and creates a filter corresponding to the determined type.

Herein, a single slice includes a plurality of image blocks, boundaries of which may have different types. Thus, a plurality of filters may be created for the single slice. For example, if boundaries are classified into a total of 4 types according to context information, 4 filters may be created for a single slice. In this situation, if different filters are created for horizontal boundaries and vertical boundaries, the total number of filters to be created may be 8. The number of boundary types classified according to the context information may be selectively determined by the encoding unit 110.

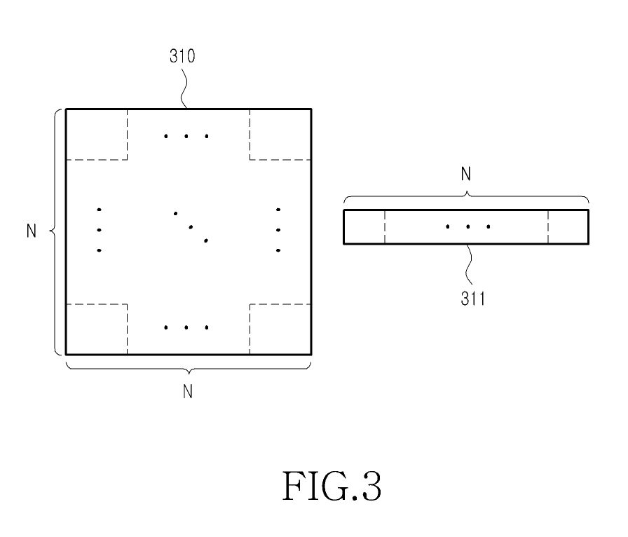

A size and a dimension of a filter created by the filter creating unit 210 may not be fixed. For example, the filter created by the filter creating unit 210 may be a 1D filter having a size of N or a 2D filter having a size of N×N. FIG. 3 illustrates examples of a 2D filter 310 having a size of N×N and a 1D filter 311 having a size of N.

When a 1D filter is created and used for filtering, the following scheme may be applied according to an exemplary embodiment. The form of the 1D filter may be a horizontal filter or a vertical filter. In this case, the horizontal filter is applied to left and right boundaries of an image block and the vertical filter is applied to top and bottom boundaries of the image block. The filter may also be applied by setting “on” or “off” in the unit of an image block. Therefore, combining both methods, the filtering scheme of the 1D filter may be classified into two methods, as described below.

According to a first method, both a horizontal filter and a vertical filter are applied to an “on” image block and neither the horizontal filter nor the vertical filter are applied to an “off” image block. In this case, for indication, each image block may use 1-bit flag information.

According to a second method, a horizontal filter and a vertical filter are independently applied or not applied. To this end, each image block may use 2-bits of flag information. In this case, it may be indicated whether the horizontal filter is applied to a current image block according to flag information controlling the horizontal filter, and it may also be indicated whether the vertical filter is applied to the current image block according to flag information controlling the vertical filter.

When filtering is performed by using an adaptively created filter, filter coefficient information of the created filter is transmitted to a receiving side. Therefore, an amount or size of filter coefficient information may be minimized according to one or more exemplary embodiments. To this end, filter coefficients of the created filter may be configured to be symmetric and a sum thereof may be set to a predetermined value.

For example, for a 5-tap 1D filter having a size of 5, let a sum of filter coefficients A, B, C, B, A be 1 (2A+2B+C=1). In this case, information of only the first filter coefficient A and the second coefficient B among the 5 filter coefficients may be transmitted to a decoder, since the 5 filter coefficients are symmetric and a sum of the 5 filter coefficients is 1. Thus, using the information of the first and second filter coefficients, the 3 other filter coefficients can be decoded.

The filter selecting unit 240 selects an optimal filter between the filter created by the filter creating unit 210 and the filter stored in the filter storing unit 230 and delivers filter information regarding the selected filter to the filtering performing unit 250. A method for selecting the optimal filter may, for example, be performed by comparing cost functions of two target filters. The cost function is a function generated by considering at least one of overhead at the time of delivering filter information regarding a filter to a receiving side, filtering performance of the filter (e.g., an error rate between a reconstructed image and an original image), and the like. If there is no previously stored filter, the filter selecting unit 240 may select the filter currently created by the filter creating unit 210.

If the filter selecting unit 240 selects the currently created filter, filter coefficient information of the created filter is delivered to the filter storing unit 230 and to the filter information generating unit 270. If the filter selecting unit 240 selects the filter stored in the filter storing unit 230, index information of the selected filter is delivered to the filter information generating unit 270.

The filter storing unit 230 updates a previously stored filter by using the filter coefficient information delivered from the filter selecting unit 240. The update of the filter may be performed by replacing the filter coefficient information of the stored filter with the filter coefficient information of the created filter. If there is no previously stored filter, the filter storing unit 230 may store filter information regarding the currently created filter.

The filtering performing unit 250 performs filtering on an image block by using the filter selected by the filter selecting unit 240.

The filter information generating unit 270 generates filter information by using information delivered from the filter selecting unit 240 and delivers the filter information to the encoding unit 110. The filter information is encoded by the encoding unit 110, and is then transmitted to a decoder of the receiving side. The filter information generated by the filter information generating unit 270 may vary according to a type of the selected filter.

If the filter selecting unit 240 selects the filter created by the filter creating unit 210, the filter information generating unit 270 may generate filter information by using filter coefficients of the currently created filter. The amount or size of the generated filter information may be reduced by using at least one of characteristics of the filter coefficients of the created filter (for example, symmetry) and a sum of the filter coefficients.

If the filter selecting unit 240 selects the filter stored in the filter storing unit 230, the filter information generating unit 270 may generate, as the filter information, index information for identifying the previously stored filter or information in the form of a flag having information indicating the reuse of the stored filter.

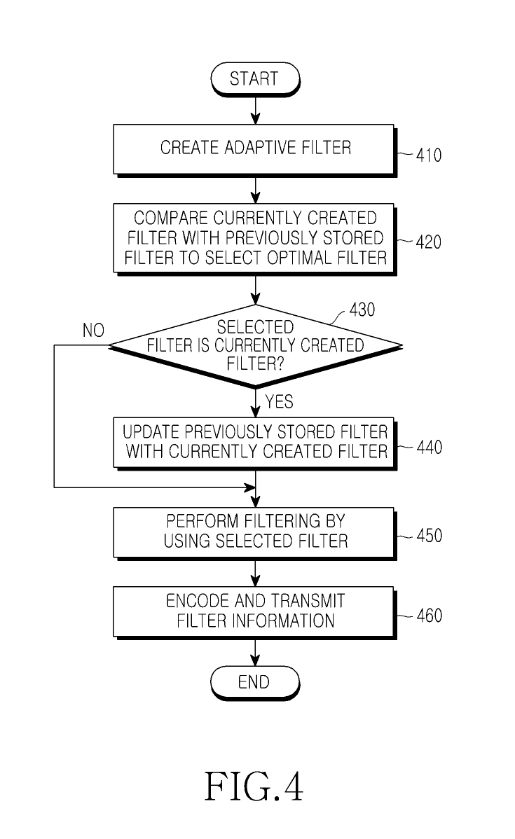

FIG. 4 is a flowchart illustrating an in-loop filtering method according to an exemplary embodiment. The method illustrated in FIG. 4 may be performed by the in-loop filter unit 130 shown in FIG. 1.

Referring to FIG. 4, in step 410, a type of a boundary of an image block is determined by using context information, and a filter corresponding to the determined type is created to minimize bitrate distortion between a reconstructed image and an original image corresponding thereto. A single slice includes a plurality of image blocks, boundaries of which may be classified into different types according to context information of adjacent image blocks. For the single slice, a plurality of filters may be created. For example, when a slice includes 4 image blocks and boundaries of the 4 image blocks are classified into predetermined N block types, a total of N filters may be created for the slice.

In step 420, an optimal filter is selected between the filter created for the determined type and a previously created and stored filter. A method for selecting the optimal filter may include comparing cost functions of two target filters. For example, the cost function is a function generated by considering at least one of overhead at the time of delivering filter information regarding a filter to a receiving side, filtering performance of the filter (e.g., an error rate between a reconstructed image and an original image), and the like. If there is no previously stored filter, the currently created filter may be selected.

If it is determined in step 430 that the selected filter is the filter created in step 410, the previously stored filter is updated with the currently created filter in step 440. The update of the filter may be performed by replacing filter coefficient information of the stored filter with filter coefficient information of the created filter. If there is no previously stored filter, filter information regarding the currently created filter may be stored. In step 450, filtering is performed on an image block by using the selected filter.

If it is determined in step 430 that the selected filter is not the currently created filter (i.e., the selected filter is the previously stored filter), filtering is performed by using the selected filter, i.e., the previously stored filter, in step 450.

In step 460, filter information regarding the filter which is used for filtering is generated and encoded for transmission to a decoder of the receiving side. The filter information may vary according to the type of the selected filter.

If the currently created filter is selected, the filter information is generated by using filter coefficients of the currently created filter. As mentioned above, the amount or size of generated filter information may be reduced by using at least one of characteristics of the filter coefficients of the created filter (for example, symmetry) and a sum of the filter coefficients.

If the previously stored filter is selected, the generated filter information may include at least one of index information for identifying the previously stored filter or information in the form of a flag having information indicating the reuse of the stored filter.

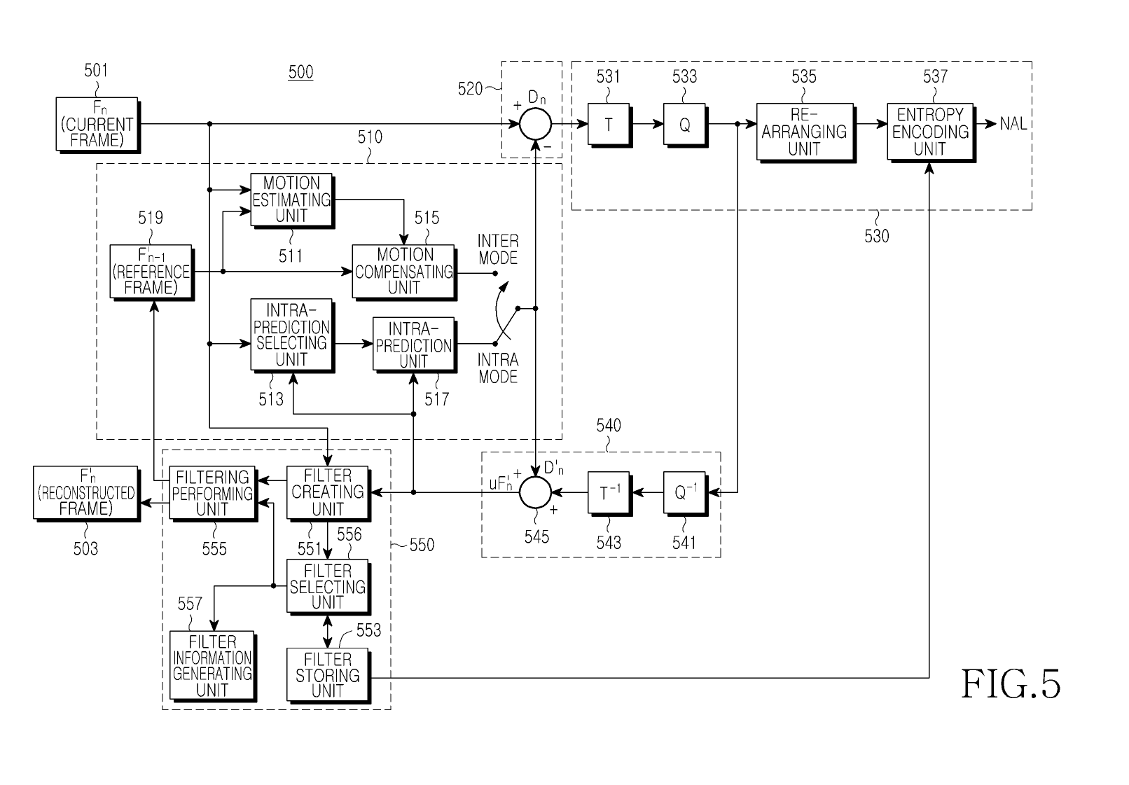

FIG. 5 is a block diagram illustrating a video encoding apparatus 500 according to an exemplary embodiment. Referring to FIG. 5, the video encoding apparatus 500 includes an image predicting unit 510, a difference signal generating unit 520, an encoding unit 530, a reconstructed image generating unit 540, and an in-loop filter unit 550.

The image predicting unit 510 generates a predicted image of a current frame 501 from a reference frame 519. The current frame 501 corresponds to an original image which is to be currently encoded, and the reference frame 519 corresponds to a reference image to which an in-loop filter has been applied.

The image predicting unit 510 includes a motion estimating unit 511, an intra-prediction selecting unit 513, a motion compensating unit 515, and an intra-predicting unit 517. The motion estimating unit 511 estimates a motion of the current frame 501 by using the reference frame 519, and the motion compensating unit 515 compensates for a motion of the reference frame 519. When a predicted image is to be generated in an intra mode, the intra-prediction selecting unit 513 generates the predicted image of the current frame 501 from a reconstructed image through the intra-predicting unit 517.

The difference signal generating unit 520 subtracts the predicted image generated by the image predicting unit 510 from the current frame 501, thus generating a difference signal D.

The encoding unit 530 includes a Discrete Cosine Transform (DCT) unit 531 which performs DCT on the difference signal, a quantizing unit 533 which performs quantization, a re-arranging unit 535 which re-arranges quantized data, and an entropy encoding unit 537 which performs entropy encoding on the re-arranged data.

The reconstructed image generating unit 540 may include an inverse quantizing unit 541, an Inverse Discrete Cosine Transform (IDCT) unit 543, and an adder 545. For encoding of a next block or a next frame, the reconstructed image generating unit 540 reconstructs an image by compensating for an original block during encoding of a current block or a current frame.

The in-loop filter unit 550 applies filtering to the reconstructed image based on an adaptive in-loop filter for the reconstructed image output from the reconstructed image generating unit 540. The in-loop filter unit 550 includes a filter creating unit 551, a filter selecting unit 556, a filter storing unit 553, a filtering performing unit 555, and a filter information generating unit 557. It is understood that the operations of the filter creating unit 551, the filter selecting unit 556, the filter storing unit 553, the filtering performing unit 555, and the filter information generating unit 557 are substantially similar to those of the filter creating unit 210, the filter selecting unit 240, the filter storing unit 230, the filtering performing unit 250, and the filter information generating unit 270 illustrated in FIG. 2, and thus will not be described in detail herein.

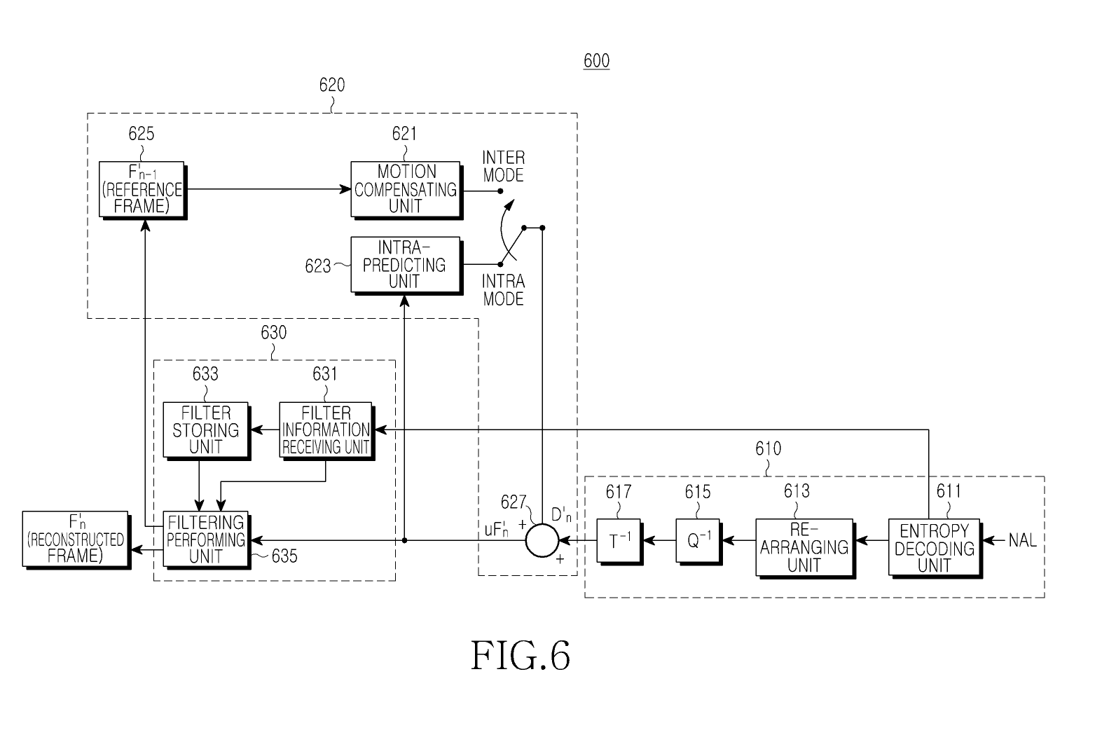

FIG. 6 is a block diagram illustrating a video decoding apparatus 600 according to an exemplary embodiment. Referring to FIG. 6, the video decoding apparatus 600 includes a decoding unit 610, a reconstructed image generating unit 620, and an in-loop filter unit 630.

The decoding unit 610 restores a difference signal by decoding an input bitstream. The decoding unit 610 includes an entropy decoding unit 611, a re-arranging unit 613 which re-arranges decoded data, an inverse quantizing unit 615 which performs inverse quantization, and an IDCT unit 617 which performs IDCT.

The reconstructed image generating unit 620 generates the reconstructed image by using the difference signal and a predicted image. The reconstructed image generating unit 620 includes a motion compensating unit 621 which performs motion compensation from a reference frame 625, an intra-predicting unit 623 which performs intra-prediction, and an adder 627 which generates the reconstructed image by adding the predicted image to the difference signal.

The in-loop filter unit 630 includes a filter information receiving unit 631, a filter storing unit 633, and a filtering performing unit 635.

The filter information receiving unit 631 receives filter information included in the input bitstream from the decoding unit 610. If the received filter information is filter coefficient information, the received filter information may include at least one of index information for identifying a previously stored filter and information in the form of, for example, a flag having information indicating the reuse of the stored filter.

The filter information receiving unit 631 generates filter coefficients or index information or flag information of a filter stored in the filter storing unit 633 by using the received filter information.

When the generated information is filter coefficient information, the filter information receiving unit 631 delivers the filter coefficient information to the filtering performing unit 635 and the filter storing unit 633. When the generated information is index information or flag information, the filtering performing unit 635 delivers the index information or the flag information to the filter storing unit 633.

The filter storing unit 633, when receiving the filter coefficient information from the filter information receiving unit 631, updates a previously stored filter by using the filter coefficient information. The filter storing unit 633, when receiving index information from the filter information receiving unit 631, selects a filter corresponding to the index information from among previously stored filters and delivers a filter coefficient of the selected filter to the filtering performing unit 635. When receiving flag information, the filter storing unit 633 delivers a filter coefficient of a currently stored filter to the filtering performing unit 635.

The filtering performing unit 635 performs filtering on the reconstructed image by using the filter coefficient information delivered from the filter information receiving unit 631 or the filter storing unit 633.

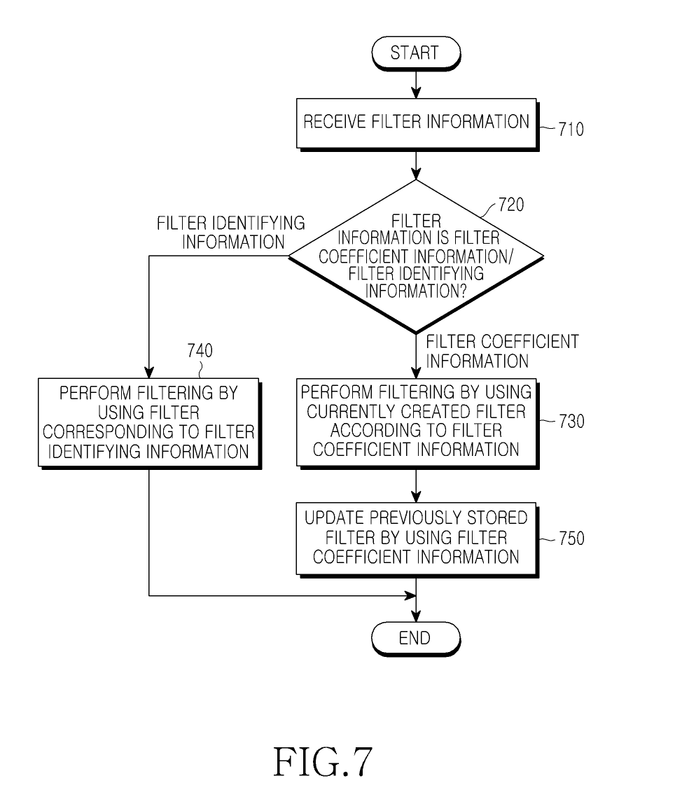

FIG. 7 is a flowchart illustrating an in-loop filtering method performed by a video decoding apparatus according to an exemplary embodiment. The method illustrated in FIG. 7 may be performed by the in-loop filter unit 630 shown in FIG. 6.

Referring to FIG. 7, in step 710, filter information transmitted from a video encoding apparatus is received.

In step 720, it is determined whether the received filter information is filter coefficient information or filter identifying information, e.g., index information for identifying a filter or information in the form of a flag indicating the reuse of a previously stored filter.

If the filter information is the filter coefficient information, filtering is performed by using a currently created filter according to the filter coefficient information in step 730, and a previously stored filter is updated in step 750.

If the filter information is the filter identifying information, filtering is performed on an image block by using the previously stored filter according to the filter identification information.

As described above, exemplary embodiments adaptively create a filter which minimizes bitrate distortion between a reconstructed image and an original image by using context information of the reconstructed image, selects an optimal filter between the created filter and a previously stored filter, and performs filtering by using the selected filter, thereby allowing optimal filtering according to characteristics of an image. Thus, more precise prediction during motion estimation and compensation is provided, together with improvement in encoding efficiency.

While not restricted thereto, exemplary embodiments can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, exemplary embodiments may be written as computer programs transmitted over a computer-readable transmission medium, such as a carrier wave, and received and implemented in general-use or special-purpose digital computers that execute the programs. Moreover, while not required in all aspects, one or more units of the video encoding apparatus 500 and the video decoding apparatus 600 can include a processor or microprocessor executing a computer program stored in a computer-readable medium.

While exemplary embodiments have been shown and described, it will be understood by those skilled in the art that various changes in form and details may be made therein without departing from the spirit and scope of the present inventive concept as defined by the appended claims.

What is claimed is:

1. An in-loop filtering method for video encoding, the in-loop filtering method comprising:
determining a type of a boundary of an image block to be filtered by using context information of the image block;
adaptively creating a filter for filtering the boundary of the image block according to the determined type of the boundary;
selecting a filter for filtering the image block from among the created filter and a previously stored filter; and
filtering the image block by using the selected filter.

2. The in-loop filtering method of claim 1, wherein the context information comprises at least one of a boundary strength of the image block, a pixel position with respect to the boundary of the image block, a macroblock encoding mode, whether a macroblock encoding mode is a skip mode, a Coded Block Pattern (CBP), a Quantization Parameter (QP), and a motion vector.

3. The in-loop filtering method of claim 1, wherein when the selected filter is the created filter, the stored filter is updated by using filter information regarding the created filter.

4. The in-loop filtering method of claim 1, further comprising generating filter information regarding the selected filter and transmitting the generated filter information to a video decoding apparatus.

5. An in-loop filtering apparatus for video encoding, the in-loop filtering apparatus comprising:
a filter creating unit which determines a type of a boundary of an image block to be filtered by using context information of the image block, and which adaptively creates a filter for filtering the boundary of the image block according to the determined type of the boundary;
a filter selecting unit which selects a filter for filtering the image block from among the created filter and a previously stored filter; and
a filtering performing unit which filters the image block by using the selected filter.

6. The in-loop filtering apparatus of claim 5, wherein the context information comprises at least one of a boundary strength of the image block, a pixel position with respect to the boundary of the image block, a macroblock encoding mode, whether a macroblock encoding mode is a skip mode, a Coded Block Pattern (CBP), a Quantization Parameter (QP), and a motion vector.

7. The in-loop filtering apparatus of claim 5, wherein the filter storing unit updates the stored filter by using filter information regarding the created filter when the selected filter is the created filter.

8. The in-loop filtering apparatus of claim 5, further comprising a filter information generating unit which generates filter information regarding the selected filter and which transmits the generated filter information to a video decoding apparatus.

9. An in-loop filtering method for video decoding, the in-loop filter method comprising:
receiving filter information regarding a filter used to filter an image block from a video encoding apparatus;
when the received filter information comprises filter coefficient information, filtering the image block by using a filter corresponding to the filter coefficient information; and
when the received filter information comprises information of a previously stored filter, filtering the image block by using a filter corresponding to the information of the previously stored filter.

10. The in-loop filtering method of claim 9, further comprising updating the previously stored filter with the filter coefficient information when the received filter information comprises the filter coefficient information.

11. The in-loop filtering method of claim 9, wherein the filter coefficient information is adaptively based on a type of a boundary of the image block.

12. The in-loop filtering method of claim 9, wherein the information of the previously stored filter is index information or flag information.

13. An in-loop filtering apparatus for video decoding, the in-loop filtering apparatus comprising:
a filter information receiving unit which receives filter information regarding a filter used to filter an image block from a video encoding apparatus; and
a filtering performing unit which filters the image block by using a filter corresponding to filter coefficient information when the received filter information comprises the filter coefficient information, and which filters the image block by using a filter corresponding to information of a previously stored filter when the received filter information comprises the information of the previously stored filter.

14. The in-loop filtering apparatus of claim 13, wherein the filter storing unit updates the previously stored filter with the filter coefficient information when the received filter information comprises the filter coefficient information.

15. A method of adaptively creating a filter for an in-loop filtering of an image block, the method comprising:
determining a type of a boundary of the image block by using context information of the image block; and
adaptively creating the filter for filtering the boundary of the image block according to the determined type of the boundary.

16. An in-loop filtering method for video decoding, the in-loop filter method comprising:
receiving filter information regarding a filter used to filter an image block from a video encoding apparatus; and
filtering the image block by using the filter,
wherein the filter is adaptively based on a type of a boundary of the image block.

17. A computer readable recording medium having recorded thereon a program executable by a computer for performing the method of claim 1.

18. A computer readable recording medium having recorded thereon a program executable by a computer for performing the method of claim 9.

19. A computer readable recording medium having recorded thereon a program executable by a computer for performing the method of claim 15.

20. A computer readable recording medium having recorded thereon a program executable by a computer for performing the method of claim 16.
